(19) United States
(12) Patent Application Publication
(10) Pub. No.: US 2009/0167274 A1
(43) Pub. Date: Jul. 2, 2009

(54) PWM CONTROLLER AND THE CHIP THEREOF

(75) Inventors: MAO CHUAN CHIEN, HSINCHU (TW); KENT HUANG, HSINCHU (TW); HSIANG LIN HUANG, HSINCHU (TW); SHUN HAU KAO, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED ANALOG TECHNOLOGY, INC., HSINCHU (TW)

(21) Appl. No.: 12/203,043

(22) Filed: Sep. 2, 2008

(30) Foreign Application Priority Data
Dec. 28, 2007 (TW) 096150699

(51) Int. Cl. G05F 1/62

(52) U.S. Cl. 323/285

(57) ABSTRACT

A PWM controller applied to a switching voltage regulator comprises a disabling circuit, a power-sensing circuit, an over-current protection circuit and a PWM logic circuit. The disabling circuit is connected to an external frequency compensation circuit for detecting a voltage used to stop the operation of the PWM controller. The power-sensing circuit is configured to stop the operation of the PWM controller if the input voltage of the high side switch is lower than a threshold. The over-current protection circuit is configured to monitor current flowing through the output circuit, and the over-current protection circuit generates an over-current protection signal when the current exceeds a threshold. The PWM logic circuit is connected to the outputs of the disabling circuit, power-sensing circuit and over-current protection circuit.

### BACKGROUND OF THE INVENTION

1. Field of the Invention

The present invention relates to a switching voltage regulator, and more particularly, to a pulse width modulation (PWM) controller implemented in a package of exactly eight pins.

2. Description of the Related Art

Generally, the function of a switching voltage regulator is to switch a pair of serially-connected high side and low side switches so as to transform an input voltage into a stable output voltage. In practice, the front end of the switching voltage regulator is connected to a PWM controller, and thus the switching voltage regulator is operative in a PWM manner. Normally, there are three basic functions needed if the PWM controller is implemented in a chip. The first function is to use a disable signal to stop the operation of the PWM control chip. The second function is to detect the input voltage of the switching voltage regulator. When the input voltage is lower than a threshold, the operation of the PWM control chip is suspended to protect the supply load of the switching voltage regulator. The third function is to detect the output current of the switching voltage regulator. When the output current is greater than a threshold, the operation of the PWM control chip is suspended to protect the supply load of the switching voltage regulator.

However, there is an important requirement to reduce the number of pins in a chip. Even as more functions are added in a chip, the system manufacturer usually requests the IC manufacturer to limit their IC to the same number of pins. Therefore, a key issue is to design a PWM control chip that features the above three functions without increasing the number of pins used.

### SUMMARY OF THE INVENTION

The present invention proposes a PWM controller that is applied to a switching voltage regulator. The switching voltage regulator includes a high side switch, a low side switch and an output circuit. The PWM controller comprises a disabling circuit, a power-sensing circuit, an over-current protection circuit and a PWM logic circuit. The disabling circuit is connected to an external frequency compensation circuit for detecting a voltage used to stop the operation of the PWM controller. The power-sensing circuit is configured to stop the operation of the PWM controller if the input voltage of the high side switch is lower than a threshold. The over-current protection circuit is configured to monitor current flowing through the output circuit, and the over-current protection circuit generates an over-current protection signal when the current exceeds a threshold. The PWM logic circuit is connected to the outputs of the disabling circuit, power-sensing circuit and over-current protection circuit.

The present invention proposes a PWM control chip that is applied to a switching voltage regulator. The switching voltage regulator includes a high side switch, a low side switch and an output circuit. The PWM control chip is packaged with exactly eight pins and comprises a PWM controller, a high side driver and a low side driver. The high side driver is configured to drive the high side switch, and the low side driver is configured to drive the low side switch.

### BRIEF DESCRIPTION OF THE DRAWINGS

The invention will be described according to the appended drawings in which:

FIG. 1 shows a switching voltage regulator applied to a PWM controller according to one embodiment of the present invention; and

FIG. 2 shows a PWM control chip applied in a voltage switch regulator according to another embodiment of the present invention.

### PREFERRED EMBODIMENT OF THE PRESENT INVENTION

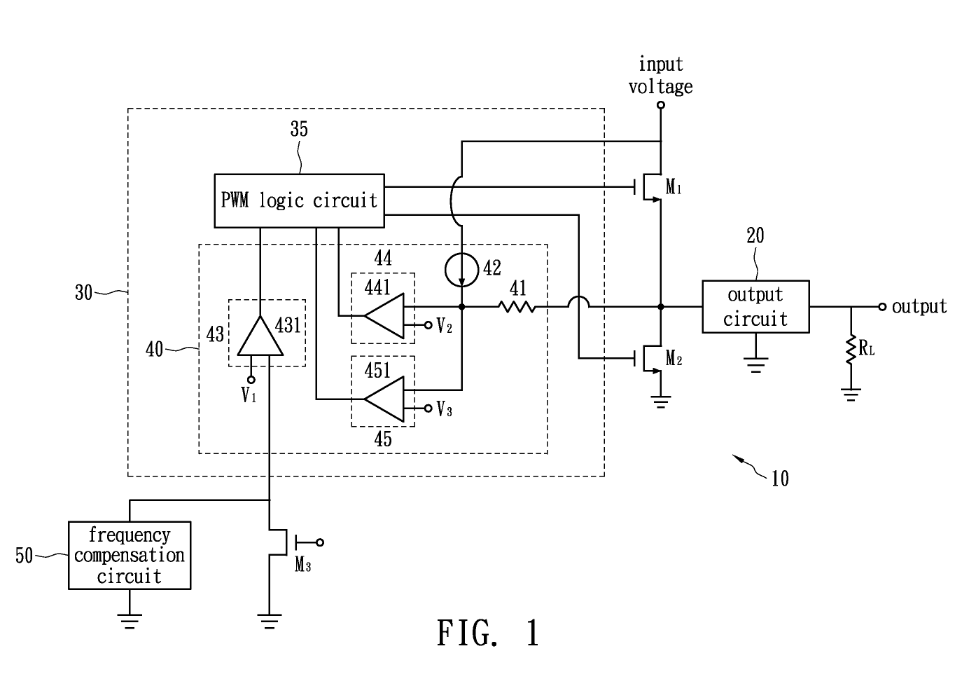

FIG. 1 shows a switching voltage regulator applied to a PWM controller according to one embodiment of the present invention. The switching voltage regulator 10 includes a high side switch M1, a low side switch M2, an output circuit 20 and a PWM controller 30, where the switching voltage regulator 10 supplies an output voltage to a load R_{L}. The PWM controller 30 includes a PWM logic circuit 35 and a circuit 40, and is used to control the operations of the high side switch M1 and the low side switch M2.

The circuit 40 includes a sensing resistor 41, a current source 42, a disabling circuit 43, a power-sensing circuit 44 and an over-current protection circuit 45. One end of the sensing resistor 41 is connected to a common node of the high side switch M1, the low side switch M2 and the output circuit 20. The output of the current source 42 is connected to the 15 other end of the sensing resistor 41. The disabling circuit 43 includes a disabling comparator 431, and its input end is connected to a switch M3 and a disable reference voltage V1, respectively. The switch M3 is connected to the frequency compensation circuit 50 of the switching voltage regulator 10 in parallel, and the frequency compensation circuit 50 is used to compensate the frequency of the output circuit 20. The power-sensing circuit 44 includes a power-sensing comparator 441 whose input end is connected to the output of the current source 42 and a power-sensing reference voltage V2, respectively. The over-current protection circuit 45 includes an over-current protection comparator 451 whose input end is connected to the output end of the current source 42 and an over-current protection reference voltage V3, respectively.

The switch M3 is a transistor whose gate terminal is connected to an external voltage. When the external voltage is high enough, the switch M3 is activated. The disabling comparator 431 is connected to the output of the switch M3 to detect a low voltage signal, which is then compared with the disable reference voltage V1 to generate a disable signal for stopping the operation of the PWM controller 30.

The sensing resistor 41 and a current source 42 are used to generate an induced voltage at the common node of the current source 42 and the power-sensing circuit 44. The power-sensing circuit 44 is used to detect the voltage of the common node of the high side switch M1 and the output circuit 20. When the input voltage of the high side switch M1 is lower than a threshold, the power-sensing circuit 44 generates a power-sensing stop signal to stop the operation of the PWM controller 30. The power-sensing comparator 441 monitors the output voltage of the high side switch M1 through the sensing resistor 41. When the input voltage of the high side switch M1 is lower than a threshold, the voltage of the common node of the current source 42 and sensing resistor 41 is lower than the power-sensing reference voltage V2, and the power-sensing comparator 441 thus generates the power-sensing stop signal.

The over-current protection circuit 45 is used to monitor the current flowing through the output circuit 20. When the current is greater than a threshold, an over-current protection signal is generated to stop the operation of the PWM controller 30. The over-current protection comparator 45 monitors the current flowing through the output circuit 20 by the sensing resistor 41. When the current is greater than a threshold, the voltage of the common node of the current source 42 and the sensing resistor 41 is lower than the power-sensing reference voltage V3, and the over-current protection comparator 45 generates an over-current protection signal.

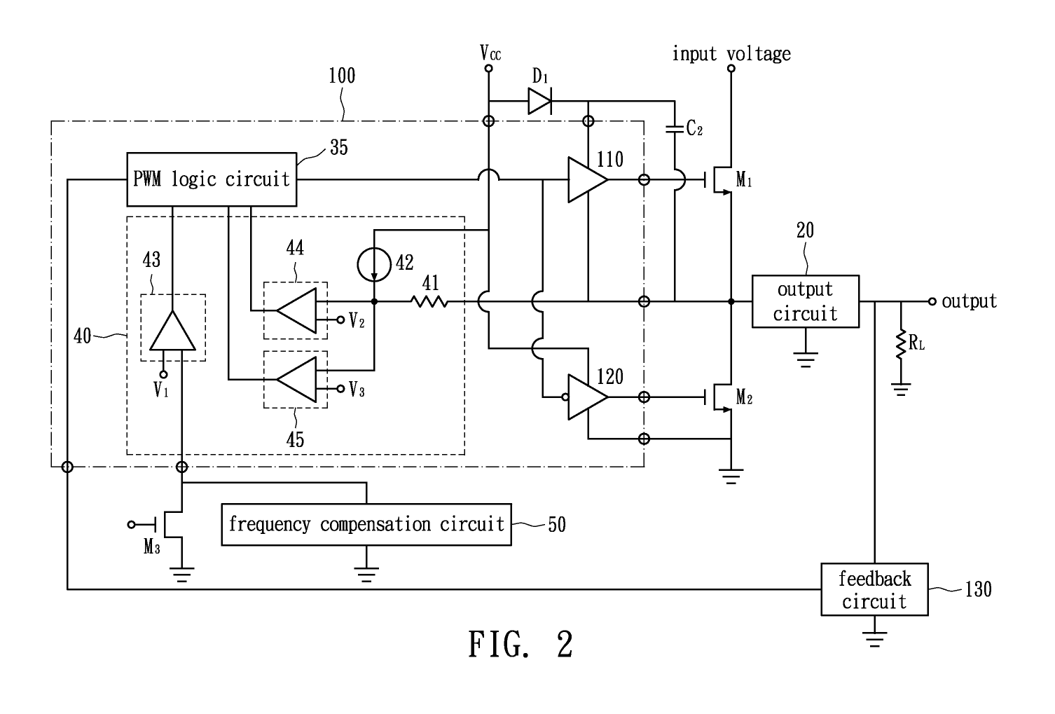

FIG. 2 shows a PWM control chip applied in a voltage switch regulator according to another embodiment of the present invention. The PWM control chip 100 is used to control the high side switch M1 and a low side switch M2, and is implemented in a package form of exactly eight pins. The output circuit 20 outputs the output voltage of the switching voltage regulator, and feeds back to the PWM control chip 100 through a feedback circuit 13.

The PWM control chip 100 includes a high side driver 110, a low side driver 120, a PWM logic circuit 35 and a combinational circuit 40 of the switching voltage regulator in accordance with the present invention. The high side driver 110 is used to drive the high side switch M1, and the low side driver 120 is used to drive the low side switch M2. The PWM logic circuit 35 is used to control the high side switch M1 and the low side switch M2.

The first pin of the PWM control chip 100 is connected to the supply voltage Vcc. The second pin is connected to the supply voltage of the high side driver 110. The third pin is connected to the output of the high side driver 110. The fourth pin is connected to the grounding end of the high side driver 110, i.e., the common node of the sensing resistor 41, the high side driver 110 and the low side driver 120. The fifth pin is connected to the output of the low side driver 120. The sixth pin is connected to the grounding end of the low side driver 120. The seventh pin is used to connect to an external frequency compensation circuit 50. The eighth pin is used to connect to the feedback circuit 130.

As shown in FIG. 2, in addition to the primary PWM function, the present PWM control chip applied in a switching voltage regulator adds disable, power-sensing and over-current protection functions. Importantly, the above newly added functions share the existing package pins, and do not increase the number of pins, thus the purpose of reducing area and cost is obtained.

The above-described embodiments of the present invention are intended to be illustrative only. Numerous alternative embodiments may be devised by persons skilled in the art without departing from the scope of the following claims.

What is claimed is:

1. A pulse width modulation (PWM) controller applied to a switching voltage regulator, the switching voltage regulator including a high side switch, a low side switch and an output circuit, the PWM controller comprising:
a disabling circuit connected to an external frequency compensation circuit for detecting a voltage used to stop the operation of the PWM controller;
a power-sensing circuit configured to stop the operation of the PWM controller if an input voltage of the high side switch is lower than a threshold;
an over-current protection circuit for monitoring current flowing through the output circuit, wherein the over-current protection circuit generates an over-current protection signal when the current exceeds a threshold; and
a PWM logic circuit connected to outputs of the disabling circuit, power-sensing circuit and over-current protection circuit.

2. The PWM controller of claim 1, further comprising:
a sensing resistor having one end connected to the output of the high side switch; and
a current source having an output connected to the other end of the sensing resistor;
wherein the output of the current source generates an induced voltage.

3. The PWM controller of claim 2, wherein the power-sensing circuit comprises:
a power-sensing comparator having inputs connected to the output of the current source and a power-sensing reference voltage, respectively;
wherein the power-sensing comparator monitors the output voltage of the high side switch through the sensing resistor, and generates a power sensing stop signal when the input voltage of the high side switch is lower than a threshold.

4. The PWM controller of claim 2, wherein the over-current protection circuit comprises:
an over-current protection comparator having inputs connected to the output of the current source and an over-current protection reference voltage, respectively;
wherein the over-current protection comparator monitors current flowing through the output circuit by the sensing resistor, and generates an over-current protection signal if the current is greater than a threshold.

5. The PWM controller of claim 1, wherein the disabling circuit comprises a disabling comparator, the disabling comparator having inputs connected to a switch and a disable reference voltage, respectively, wherein the disabling comparator generates a disable signal to stop the operation of the PWM controller if the switch is activated.

6. The PWM controller of claim 5, wherein the switch is connected to the external frequency compensation circuit in parallel.

7. The PWM controller of claim 1, wherein the frequency compensation circuit is configured to compensate the frequency of the output circuit.

8. A pulse width modulation (PWM) control chip applied to a switching voltage regulator, the switching voltage regulator including a high side switch, a low side switch and an output circuit, the PWM control chip being packaged with exactly eight pins and comprising:
a PWM controller as recited in claim 1;
a high side driver configured to drive the high side switch; and
a low side driver configured to drive the low side switch.

9. The PWM control chip of claim 8, wherein the eight pins are connected to a power supply of the PWM control chip, a power supply of the high side driver, an output of the high side driver, a grounding end of the high side driver, an output of the low side driver, a grounding end of the low side driver, the external frequency compensation circuit of the PWM control chip and a feedback circuit of the switching voltage regulator, respectively.

10. The PWM control chip of claim 8, wherein the disabling circuit is connected to a pin that is further connected to the external frequency compensation circuit.

11. The PWM control chip of claim 8, wherein the power-sensing circuit is connected to the grounding pin of the high side driver through a sensing resistor.

12. The PWM control chip of claim 8, wherein the over-current protection circuit is connected to the grounding pin of the high side driver through a sensing resistor.
